(19) United States
(12) Patent Application Publication
(10) Pub. No.: US 2026/0340105 A1
(43) Pub. Date: Oct. 29, 2026

(54) UNIFIED MODEL INTERFACE PLATFORM

(71) Applicant: International Business Machines Corporation, Armonk, NY (US)

(72) Inventors: Vivek Soni, Pune (IN); Amit Vachhani, Pune (IN); Shripad Suryakant Gandhi, Pune (IN); Kanad Kanti Jha, Bangalore (IN); Mohini Setia, Gurugram (IN)

(73) Assignee: International Business Machines Corporation, Armonk, NY (US)

(21) Appl. No.: 19/192,574

(22) Filed: Apr. 29, 2025

(51) Int. Cl. G06F 21/44

(52) U.S. Cl. CPC G06F 21/44

(57) ABSTRACT

An embodiment intercepts an input transmitted from a user device. The embodiment validates an identity of the user device transmitting the input. The embodiment filters the text data of the input, wherein the filtering comprises identifying restricted content within the text data and removing a portion of text data from the input corresponding to the identified restricted content. The embodiment authorizes a first model to execute a first task identified in the modified input. The embodiment executes, responsive to the authorizing, the first model to execute the first task, the executing producing a first execution result. The embodiment filters, responsive to the executing, the text data of the first execution result, the filtering comprising identifying restricted content within the text data and removing a portion of text data from the first execution result corresponding to the identified restricted content. The embodiment returns the modified text output to the user device.

### BACKGROUND

The present invention relates generally to artificial intelligence. More particularly, the present invention relates to a method, system, and computer program for providing a unified model interface.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

A Large Language Model (LLM) is a type of machine learning model designed for natural language processing tasks. An LLM may be trained on immense amounts of data, enabling the LLM to be capable of understanding and generating natural language and other types of content to perform a wide range of tasks. LLMs today may have the ability to infer from context, generate coherent and contextually relevant responses, translate between different languages, summarize text, answer questions, respond to queries, and even assist in creative writing or code generation tasks.

An artificial intelligence (AI) agent refers to a system or program that is capable of autonomously performing tasks on behalf of a user or another system by designing its workflow and utilizing available tools. AI agents can encompass a wide range of functionalities beyond natural language processing including decision-making, problem-solving, interacting with external environments, and executing actions. These agents can be deployed in various applications to solve complex tasks in various contexts from software design and IT automation to code-generation tools and conversational assistants. AI agents often leverage large language models (LLMs) to comprehend and respond to user inputs step-by-step and determine when to call on external tools. AI agents are sometimes referred to as LLM agents if they incorporate an LLM in their functioning.

### SUMMARY

The illustrative embodiments provide a unified model interface. An embodiment includes intercepting, using a unified interface software application, an input transmitted from a user device to a target system, the input comprising text data. The embodiment includes causing, responsive to the intercepting, an execution of a first specific program instruction, the execution of the first specific program instruction validating an identity of the user device transmitting the input. The embodiment includes causing, responsive to validating the identity of the user device, an execution of a second specific program instruction, the execution of the second specific program instruction filtering the text data, the filtering comprising identifying restricted content within the text data, and removing a portion of text data from the input corresponding to the identified restricted content, the filtering producing a modified input. The embodiment includes authorizing using a model authorization engine of the unified interface software application a first model to execute a first task identified in the modified input. The embodiment includes executing, responsive to the authorizing, the first model to execute the first task, the executing producing a first execution result, the first execution result comprising text data. The embodiment includes causing, responsive to the executing, an execution of a third specific program instruction filtering the text data of the first execution result, the filtering comprising identifying restricted content within the text data, and removing a portion of text data from the first execution result corresponding to the identified restricted content, the filtering producing a modified text output. The embodiment includes returning, responsive to the filtering, the modified text output to the user device.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example computing environment in accordance with an illustrative embodiment;

FIG. 3 depicts a block diagram of an example software module in accordance with an illustrative embodiment;

FIG. 4 depicts a block diagram of an example prompting process in accordance with an illustrative embodiment;

FIG. 5 depicts a block diagram of an example model interface process in accordance with an illustrative embodiment; and

FIG. 6 depicts a flowchart of an example process for model interfacing in accordance with an illustrative embodiment.

### DETAILED DESCRIPTION

Prompting refers to the process of providing a specific input, typically in the form of text, to guide the generation of an output by a large language model (LLM). The prompt serves as a starting point and context for the model to generate coherent and relevant output based on the provided input. The prompt influences the content, style, and structure of the generated output by conditioning the LLM's generation process.

The prompting mechanism of an LLM includes several components that work together to guide the generation of text by the LLM. The prompt serves as the initial input that influences the content generated by the model. The prompt may include a few words, a sentence, a paragraph, a code snippet, an image, or any other digital media that provides the context or theme for the generated output. The prompt may be further concatenated with an input sequence. The input sequence includes the prompt and any additional context or information that the model uses to generate an output. By combining the prompt with the input sequence, the model can generate an output that is relevant to the given prompt. The model produces an output based on the prompt and input sequence, taking into account the language patterns and context learned during training. The output reflects the influence of the prompt on the generated content.

Large language models (LLMs) are currently used in a variety of generative applications, including but not limited to, code translation, code generation, code summarization, and so on. Even further, enterprise organizations often leverage a plurality of different trained LLM agents for separate use-cases. For example, a system or organization may employ a separate LLM agent for human resources related tasks, a separate LLM agent for human resources related tasks, a separate LLM agent for human resources related tasks, and so forth. Each LLM agent may be uniquely trained and/or configured and may have differing access permissions to data stored across the system.

However, despite improvement in LLMs and prompt-engineering techniques, the rapid advancement of Artificial Intelligence (AI) technology has introduced new security concerns associated with its usage and LLMs nevertheless remain susceptible to misuse. For example, a user may attempt to retrieve confidential or sensitive information by transmitting targeted malicious prompts to the LLM. Accordingly, as LLM technology develops, malicious actors develop more advanced ways to exploit LLM technology. In addition, AI security encompasses a wide range of concerns, including defending against adversarial attacks, ensuring ethical decision-making, safeguarding data privacy, addressing model bias and fairness, and promoting AI transparency and explainability.

The present disclosure addresses the deficiencies described above by providing a process (as well as a system, method, machine-readable medium, etc.) that develops unified interface for a multi-model system environment. Embodiments of the present disclosure facilitate segregating and restricting the model usage for the end user through access control mechanisms in a multi-model system environment where multiple AI models trained with various levels of data sensitivity may be cascaded to derive certain output. Embodiments of the present disclosure effectively prevent an end user from adversarial manipulating and/or tricking an AI model to generate unauthorized output.

Embodiments of the present disclosure include a system that secures the input and output of an AI/ML model from various security concerns, including but not limited to, contextual security, data privacy and confidentiality, unauthorized use, misuse, and so forth. Embodiments of the present disclosure include validating and filtering user prompts and output of an AI model. Embodiments of the present disclosure secure inputs to the AI model and leverage prompt filtering using contextual analysis to protect crown jewel data, sensitive data, and/or to prevent any other unwanted data leakage. Further, embodiments of the present disclosure may filter the AI generated output data through various filter layers so that output is not submitted to an unauthorized model and/or returned to an unauthorized end user.

As used throughout the present disclosure, the term “contextual filtering” refers to a data filtering technique that takes into account the context or surrounding information of the data being processed. Contextual filtering involves analyzing not only the data itself but also the relevant contextual factors, such as user permissions, user preferences, historical patterns, or environmental conditions, to make filtering decisions. An embodiment includes examining text data of an input prompt to identify known malicious actions, patterns, trends, and anomalies. An embodiment applies predefined rules, algorithms, or logic to determine which data should be filtered out or retained based on the analyzed data and contextual factors.

As used throughout the present disclosure, the term “content filtering” refers to the process of screening, analyzing, and managing data or information to identify and remove unwanted, irrelevant, or inappropriate content. Content filtering may include the application of predefined criteria, rules, or algorithms to assess the content of data and determine its suitability for further processing, dissemination, or storage. The process may include excluding content that does not meet specified standards, such as regulatory compliance, data integrity, or user preferences so that only valid, appropriate, and compliant content is allowed to pass through the filtering process. An embodiment validates the identity of a user and determines their permissions and access rights within the system. An embodiment uses access control lists, role-based access control, or other access control mechanisms to restrict the user's access to confidential data based on their permissions. An embodiment selectively filters and retrieves information based on the user's permissions and access rights. By selectively filtering the content based on the user's permissions, the content filtering module ensures that only authorized information is disclosed to the user while confidential data remains protected.

As used throughout the present disclosure, the term “prohibited content” refers to any material, data, or information that is restricted from being accessed, displayed, distributed, or shared within a specific user, device, system, subsystem, model, platform, or environment. Prohibited content may include any unauthorized material that violates a policy established by an administrator of a system or organization. An embodiment includes prohibition of content based on a user's access permissions stored in a user profile that restricts the user's ability to access specific content or components of a system or platform. The user profile serves as a repository of information that defines the user's roles, privileges, and permissions within the system. By leveraging the access permissions stored in the user profile, content and system components can be prohibited or restricted to ensure that users only interact with information that aligns with their designated access rights. In an embodiment, when a user attempts to access content within the system, the access control mechanism references the user's profile to determine their level of authorization. If the user's access permissions do not grant them the necessary rights to view or interact with certain content, the system prohibits access to that content. This prohibition may manifest as content being hidden, blocked, or flagged as inaccessible to the user, thereby preventing unauthorized exposure to restricted information.

As used throughout the present disclosure, the term “security posture” refers to a system or organization's security policies, procedures, and controls that are put in place to protect against potential security threats and vulnerabilities. A system may include multiple databases to store different types of data or serve various functions within an organization. Each of these databases may have differing security postures based on the sensitivity of the data they store, the level of access required, and the potential risks associated with unauthorized access or data breaches. Different databases may be designed to store different types of data, such as customer information, financial records, or intellectual property. Each database may have its own security controls, access permissions, and encryption mechanisms based on the security requirements of the data it contains. For example, databases with highly sensitive data may have stricter access controls, such as multi-factor authentication, role-based access control, and segregation of duties, to prevent unauthorized access and data leakage. In contrast, databases with less sensitive data may have more relaxed access controls to facilitate easier data retrieval and processing.

Illustrative embodiments provide for a process for interfacing between LLM models of a multi-model system environment. An embodiment includes intercepting an input transmitted from a user device a target system, the input comprising text data. An embodiment includes validating an identity of the user device transmitting the input. An embodiment includes filtering, responsive to validating the identity of the user device, the text data of the input, the filtering comprising identifying restricted content within the text data, and removing a portion of text data from the input corresponding to the identified restricted content, the filtering producing a modified input. An embodiment includes authorizing a first model to execute a first task identified in the modified input. An embodiment includes executing, responsive to the authorizing, the first model to execute the first task, the executing producing a first execution result, the first execution result comprising text data. The embodiment includes filtering, responsive to the executing, the text data of the first execution result, the filtering comprising identifying restricted content within the text data, and removing a portion of text data from the first execution result corresponding to the identified restricted content, the filtering producing a modified text output. The embodiment includes returning, responsive to the filtering, the modified text output to the user device.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

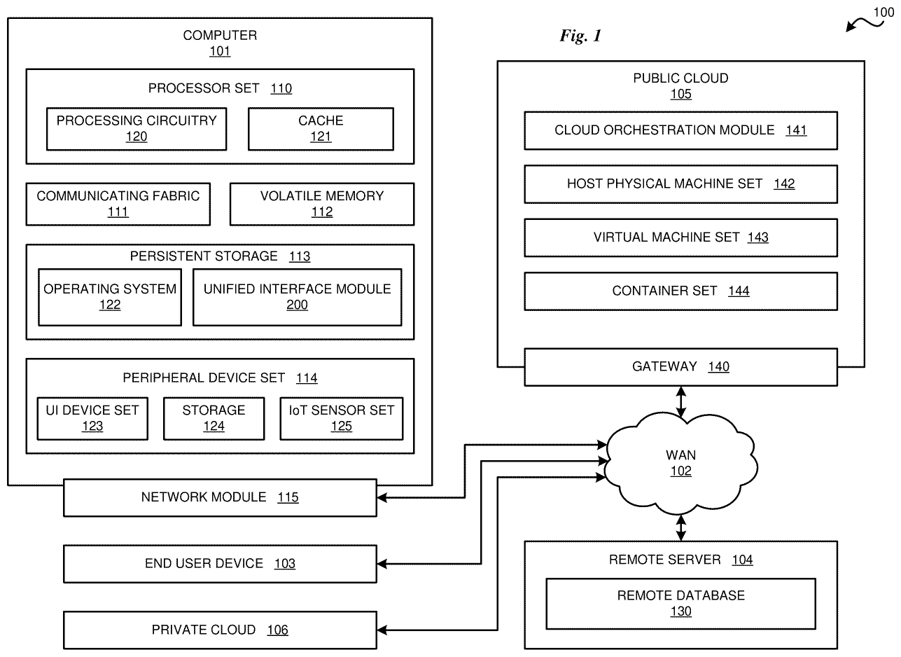

FIG. 1 depicts a block diagram of a computing environment 100. Computing environment 100 contains an example of an environment for the execution of at least some of the computer code involved in performing the inventive methods, such as unified interface module 200 that interfaces between AI/ML models of a multi-model system environment. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

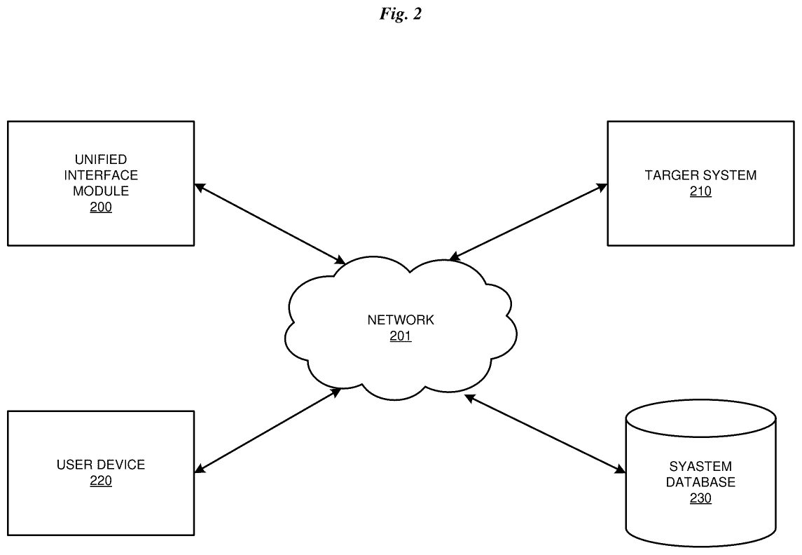

FIG. 2 depicts a block diagram of an example computing environment in accordance with an illustrative embodiment. In the illustrated embodiment, the unified interface module 200 includes the unified interface module 200 of FIG. 1. In the illustrative embodiment, the unified interface module 200 is configured to facilitate data exchange and interaction between subsystems of a multi-model system environment across any suitable network 201.

In an embodiment, the unified interface module 200 includes an input validation module, a model exchange interface, and an output validation module. The model exchange interface facilitates the exchange between different large language models (LLMs) based on the task requirements included in the input prompt and the user permissions. This component manages the selection, loading, and communication between various LLMs to perform the specific task defined by the input prompt. In an embodiment, the unified interface module 200 considers factors such as the task requirements, complexity of the task, the domain expertise required, and the user's permissions to access certain models.

In an embodiment, the input validation module is responsible for validating and/or filtering the input data received by the unified interface module 200. In an embodiment, the validation module reformats the input into a correct format, free from errors, and/or to be compliant with predefined standards, constraints, or permissions. By validating the input data, the input validation module helps prevent potential security vulnerabilities, data corruption, or system malfunctions that may arise from invalid input. In an embodiment, the output validation module is responsible for validating the output information generated by the LLMs before it is presented to the user or another subsystem of target system 210. The output validation module provides that the output contains information that is relevant, accurate, and compliant with the user's permissions and task requirements. In an embodiment, the output validation module checks for sensitive information, errors, inconsistencies, and ensures that the output is suitable for dissemination to the user based on the defined criteria.

In an embodiment, the input validation module filters prompt input based on the user's access permission by implementing access control mechanisms. Access control mechanisms may be configured to restrict a user's access to certain resources based on their permissions, roles, or privileges within the system. In an embodiment, the input validation module verifies the user's identity and authentication credentials to determine their access level, providing that only authorized users are allowed to interact with the system and its components, including a large language model (LLM) and selected databases. In an embodiment, the input validation module checks the user's access permissions against the defined policies and rules. These access control policies may specify what actions or resources each user is allowed to access, modify, or interact with. In an embodiment, based on the user's permissions, the input validation module filters the prompt input to ensure that only authorized requests are processed.

In an embodiment, the filtering process includes comparing the user's access permissions with the requirements of the input prompt. If the user's permissions do not align with the task requirements or if the input prompt contains sensitive information that the user is not authorized to access, the input validation module blocks or restricts the input from proceeding further. By filtering prompt input based on the user's access permission, the input validation module prevents unauthorized access to an LLM model and/or database. This proactive security measure helps safeguard sensitive data, intellectual property, and system resources from unauthorized users, thereby maintaining the integrity and confidentiality of the system.

In an embodiment, the unified interface module 200 is configured to secure data exchange and generation in a multi-model environment using a combination of identity and access management (IAM), contextual analysis, and prompt filtering techniques. By integrating IAM, contextual analysis, input prompt filtering, and output prompt filtering techniques into the unified interface module, the target system 210 can enhance security, privacy, and compliance measures throughout the input provision and output generation processes. These techniques help mitigate risks associated with unauthorized access, data breaches, and inappropriate content, ensuring a secure and reliable interaction between users and the AI/ML models.

In an embodiment, IAM is utilized to authenticate and authorize users before a user can communicate with the AI/ML models. IAM ensures that only authenticated users with the appropriate permissions can access and interact with the system. Users are assigned specific roles and permissions that determine their level of access to the AI/ML models and data exchange processes.

In an embodiment, contextual analysis is employed to analyze the context of the input prompts and data exchange in the multi-model environment. By considering the context in which the prompts are provided and the data is exchanged, the system can make more informed decisions about how to process and respond to user inputs. Contextual analysis helps improve the accuracy and relevance of the AI/ML models' outputs.

In an embodiment, one or more prompt filtering techniques are applied to filter input prompts before they are sent to the AI/ML models. This filtering process may include checking for objectionable content, personally identifiable information (PII), regulatory-sensitive data, and other predefined criteria. Prompt filtering ensures that only appropriate and compliant prompts are processed by the models, reducing the risk of unauthorized access or data breaches. In an embodiment, one or more output filtering techniques are used to validate and filter the output generated by the AI/ML models before the output is returned to the user or to another model. This filtering process may include checking the output for sensitive information, inappropriate content, or any other predefined criteria. Output filtering ensures that the information presented to the user is accurate, relevant, and compliant with the system's security and privacy policies.

In the illustrated embodiment, the system database 230 includes a repository for all data related to target system 210. In an embodiment, the system database 230 stores data accessed by one or more AI/ML models when executing tasks. Although a single database 230 is shown, it is contemplated herein that the target system 210 may encompass multiple databases with varying security policies to control access based on user permissions or model requirements.

In an embodiment, each database within the target system 210 may have distinct security policies and access controls in place to regulate data access and ensure data confidentiality and integrity. These security policies may restrict access to specific databases based on user roles, privileges, or authentication credentials. For example, certain databases may only be accessible to authorized users with specific permissions, while others may have more relaxed access controls for general data retrieval. Furthermore, the target system 210 may implement data segregation strategies to partition sensitive data into separate databases with heightened security measures. This segregation helps prevent unauthorized access to confidential information and minimizes the risk of data breaches or unauthorized disclosures. By segmenting data across multiple databases with varying security policies, the target system 210 can enforce a principle of least privilege, granting access only to those users or models that require it for their designated tasks.

In the illustrated embodiment, user device 220 includes a computing device configured to facilitate user interaction with the unified interface module 200, thereby enabling a user to engage with the management of various operations related to target system 210. Accordingly, user device 220 may serve as an interface through which users can communicate instructions, commands, or requests to the unified interface module 200, initiating related actions and overseeing the target system's performance. Through user device 220, a user can access a user interface or application that allows the user to interact with the unified interface module 200. Users may input commands, configure settings, and monitor system performance through the interface provided by user device 220. In an embodiment, a user accessing user device 220 prompts a large language model executed as a part of target system 210 with an input prompt.

In an embodiment, user device 220 may support various communication channels, such as a graphical user interface (GUI), a command-line interface (CLI), a web-based portal, or a mobile application, depending on the system's design and user requirements. Users can communicate with the unified interface module 200 in real-time to view visualizations related to operations disclosed herein.

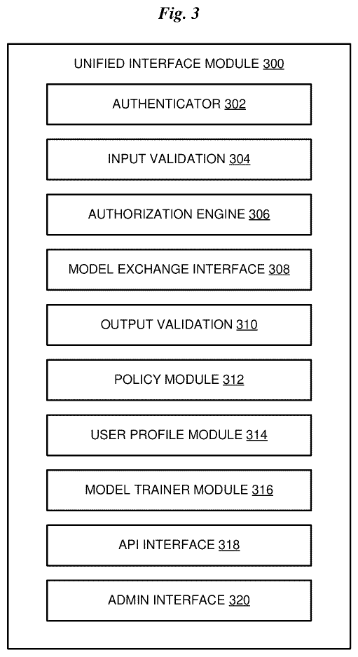

FIG. 3 depicts a block diagram of an example unified interface software module 300 in accordance with an illustrative embodiment. In the illustrated embodiment, unified interface module 300 is an example of unified interface module 200 of FIGS. 1 and 2.

In the illustrated embodiment, the unified interface module 300 includes a software module including a plurality of other software modules, including an authenticator module 302, an input validation prompt module 304, an authorization engine module 306, a model exchange interface module 308, an output validation module 310, a policy module 312, a user profile module 314, a model trainer module 316, an API interface module 318, and an administrator interface module 320. In alternative embodiments, unified interface module 300 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In some embodiments, the unified interface module 300 comprises a physical computing device, including but not limited to, a general-purpose computer, a mainframe computer, a supercomputer, a quantum computer, a computer server, a personal computer, a laptop, a smartphone, a tablet, a personal digital assistant (PDA), etc., and any combination thereof. In some embodiments, the unified interface module 300 comprises specialized hardware, such as for example, an Application-Specific Integrated Circuit (ASIC) or Field-Programmable Gate Array (FPGA) for accelerated processing of specific tasks, routines, algorithms, training operations, etc. In some embodiments, the unified interface module 300 may include a combination of physical and virtualized components, as well as may be partially or entirely virtualized on a virtual machine.

In the illustrated embodiment, the authenticator module 302 includes a software module configured to authenticate a user attempting to transmit and input to a system, database, or AI/ML model. In an embodiment, the authenticator module 302 is configured to verify the identity of a user accessing the system by authenticating the user based on the user's credentials, which may include, but are not limited to, usernames, passwords, biometric data, or multi-factor authentication methods. The authenticator module 302 provides that only authorized individuals can interact with the system, preventing unauthorized access to the system, system components, machine learning models, and/or confidential data associated with the system. In an embodiment, the authenticator module 302 authenticates a user based on user profile information.

In an embodiment, once access to one or more models is authorized, the unified interface is configured to input a filtered prompt to the authorized model. The input prompt undergoes validation and filtering to ensure that it meets predefined criteria such as objectionable content, regulatory compliance, or data sensitivity. Accordingly, the unified interface 200 acts as a gateway for users to input prompts that are then processed by the authorized models, ensuring that only appropriate and compliant inputs are utilized for generating outputs.

In an embodiment, after the authorized model processes the input prompt and generates an output, the unified interface is configured to filter and validate the output before the output is transmitted to another model for further processing. This filtering and validation step ensures that the output aligns with the prompt content, task requirements, user permissions, and defined policies of the system to ensure compliance as the output is passed on to subsequent models for additional analysis or processing, providing interaction and data exchange between different components of the multi-model system environment.

In the illustrated embodiment, the input validation module 304 includes a software module configured to validate the contents of a prompt transmitted to a machine learning model. In an embodiment, the input validation prompt module 304 is configured to validate the input prompts provided by a user before the prompt is processed by one or more of the AI/ML models of a multi-model system environment. In an embodiment, the input validation prompt module 304 executes specifically purposed code to check the format, content, and structure of an input prompts to validate that the input prompt meets the system's predefined criteria, requirements and standards, thereby providing that errors and unauthorized inputs are prevented from entering the system.

In the illustrated embodiment, the authorization engine module 306 includes a software module configured to manage user permissions and access control within the system. In an embodiment, the authorization engine module 306 enforces access policies defined in the system's security framework to determine what actions users are allowed to perform and what resources users can access. By enforcing authorization rules, the authorization engine module 306 provides that users only interact with components and data they are authorized to access. Further, by authorizing access to multiple models, the unified interface module establishes a secure and controlled environment for users to engage with the diverse range of models available in the multi-model system environment.

Suppose for example that a successful execution of some task based on a user input query requires execution of multiple sub-tasks, such as a first task and a second task. In an embodiment, the process may include executing a first model to execute the first task and executing a second model to execute the second task. In an embodiment, executing the first model to execute the first task comprises retrieving information from a first database. In an embodiment, the first database comprises a first security posture. In an embodiment, executing the second model to execute the second task comprises retrieving information a second database. In an embodiment, the second database comprising a second security posture. In an embodiment, the authorization engine module 306 is configured to manage user access to each model and/or database based on the user's access permissions respective of the differing security postures. By requiring validation of access to each model and/or database based on the security postures of the respective databases, systems and organizations can maintain a granular level of control over user access rights, mitigate the risk of unauthorized data access or manipulation, and uphold the confidentiality and integrity of the data stored within each database.

In the illustrated embodiment, the model exchange interface module 308 includes a software module configured to facilitate the exchange of data and communication between different AI/ML models based on the task requirements and user permissions. In the illustrated embodiment, the model exchange interface module 308 manages the selection, loading, and interaction between various models to perform specific tasks defined by the input prompts, providing integration and interoperability between different models of a multi-model system environment. In an embodiment, model exchange interface module 308 interfaces between multiple models trained and employed for various tasks and/or use-cases based on authorization provided by authorization engine module 306. In an embodiment, the unified interface module 300 authorizes access to various models based on user permissions, task requirements, and/or system policies. This authorization provides that a user is granted access only to the models they are permitted to interact with, aligning with the user's roles, responsibilities, and/or permissions within the system.

In the illustrated embodiment, the model output validation module 310 includes a software module configured to validate the output generated by the AI/ML models before the output is presented to the user or another model. In an embodiment, the model output validation module 310 checks the accuracy, relevance, and compliance of the output information against a predefined criteria to ensure the output meets the system's security framework and user requirements.

In the illustrated embodiment, the policy module 312 includes a software module configured to define and enforce the security and compliance policies governing the system's operation. The Policy Module includes rules, regulations, and guidelines that dictate how data is handled, accessed, and processed within the system. In an embodiment, the policy module 312 provides a framework for creating, managing, and enforcing access control policies that govern user interactions with various AI/ML models. For example, a user with elevated privileges, such as system administrators or designated policy managers, can access the policy module 412 to define specific policies that regulate user access to different models based on their roles, responsibilities, and permissions. These policies can include rules dictating which users can access specific models, what actions they can perform, and under what conditions access is granted or restricted. This allows for tailored access control mechanisms that ensure users only interact with models that are relevant to their tasks and responsibilities, while also safeguarding sensitive data and intellectual property. A policy may be dynamically adjusted and updated as needed to reflect changes in user roles, model availability, or security requirements. In an embodiment, the policy module 312 facilitates the definition of policies tailored to different use-cases or components of an enterprise, providing a customizable framework for creating access control rules that may be specific to select scenarios.

In the illustrated embodiment, the user profile module 314 includes a software module configured to store and manage user profiles, including information such as user roles, permissions, preferences, and access rights. In an embodiment, the user profile module 14 maintains a record of each user's attributes and settings which may be leveraged to customize a user's authorized interactions with the system and provide that appropriate access is granted based on a user's profile information.

In the illustrated embodiment, the model trainer module 316 includes a software module configured to train one or more machine learning models described herein. In an embodiment, model training module 316 includes a data preparation module, an algorithm module, a training engine, and a machine learning model. In alternative embodiments, model training module 316 can include some or all of the functionality described herein but grouped differently into one or more modules. In some embodiments, model trainer module 316 generates a machine learning model based on one or more known machine learning algorithms. In an embodiment, model trainer module 316 includes a training engine that trains machine learning model using training a dataset.

In the illustrated embodiment, the model trainer module 316 is configured to train a large language model using feedback derived from execution results, prompts, and recommendations generated by the system and/or from external sources. In an embodiment, the training process includes fine-tuning, transfer learning, and/or reinforcement learning, to enhance the model's performance and accuracy. Through iterative training iterations, the module refines the model's generation abilities, fine-tunes its parameters, and adjusts its behavior based on the feedback received during the training process. In an embodiment, model trainer module 316 continuously evaluates the model's performance against predefined evaluation metrics and thresholds to monitor training progress and ensure that trained model meets the desired standards of accuracy and quality. By analyzing the model's outputs and comparing them against the defined metrics, the model trainer module 316 iteratively refines the model's training process to optimize generation performance.

In the illustrated embodiment, the model trainer module 316 is configured to configure a large language model for a particular use-case. In an embodiment, a system or organization can configure a large language model for a particular use-case by identifying specific requirements and objectives of the use case, which may include training a model to understand the domain-specific language, terminology, and context relevant for the use-case. An embodiment gathers and preprocesses a dataset relevant to the use case. This dataset may include a diverse range of examples and scenarios relevant to the use case. The dataset may be cleaned, annotated, and structured in a way that is suitable for training the model effectively. An embodiment selects a suitable pre-trained large language model as a base and fine-tune it using the domain-specific dataset. Fine-tuning may include updating the parameters of the pre-trained model using the new dataset to adapt it to the specific use case. An embodiment includes adjusting the hyperparameters of the model during training to improve its performance for the particular use case. Hyperparameters such as learning rate, batch size, and number of training epochs can be adjusted to achieve the desired level of accuracy and efficiency. Once the model has been fine-tuned and optimized, the model trainer module 316 may evaluate its performance using metrics relevant to the use case, such as accuracy, precision, recall, and F1 score. Continuous monitoring and feedback loops can be established to further improve the model's performance over time based on real-world usage and feedback.

In the illustrated embodiment, the model trainer module 316 employs a human-in-the-loop reinforcement learning process to fine-tune the model. In an embodiment, the process includes integrating human feedback into the training process to guide and improve the model's performance iteratively. In an embodiment, when the LLM generates output that is flagged by content filtering as potentially incorrect, inappropriate, or irrelevant, the user provides corrective feedback to guide future output generation.

Through human-in-the-loop reinforcement learning, the model trainer module 316 leverages the flagged output instances to adjust and refine the LLM's parameters and decision-making processes. The user's corrective feedback serves as reinforcement signals that help the model learn from its mistakes and make adjustments to improve its output quality. By incorporating human feedback into the training loop, the LLM can adapt and optimize its responses based on real-time guidance from the user, enhancing its accuracy and relevance over time. The iterative reinforcement learning causes the LLM to continuously learn and improve its output generation capabilities based on the corrective feedback provided by the user. This interactive training process enables the model to adapt to evolving requirements, user preferences, and contextual nuances, leading to more accurate and contextually relevant output.

In the illustrated embodiment, the API interface module 318 serves as the interface through which users and/or applications interact with the unified interface module 300 and/or agents orchestrated by the unified interface module 300 and facilitates the exchange of information between the users and/or applications and these modules. In an embodiment, the application interface module 318 is configured to interact with any or all other modules within unified interface module 300 to retrieve, transmit, store, and/or modify information and/or execute functions and operations as described herein. In some embodiments, API interface module 318 connects with API gateway via any suitable network or combination of networks such as the Internet, etc. and uses any suitable communication protocols such as Wi-Fi, Bluetooth, etc. to connect to external systems required to access to perform certain tasks. Further, the API gateway may transmit service requests received from a client interacting with unified interface module 300.

In the illustrated embodiment, administrative module 320 allows users with administrative privileges to perform various administrative tasks associated with unified interface module 300 as described herein. For example, in some embodiments, administrative user module 320 allows a user with administrative privileges to initiate a data collection process. As another example, in some embodiments, administrative module 320 allows a user with administrative privileges to initiate and monitor the training process performed by model training module 316, including setting desired parameters and/or hyperparameters for the training process.

In an embodiment, administrative module 320 includes a user interface configured to allow a user having sufficient privileges to oversee the operation and management of a large language model-based system. In an embodiment, administrator module 320 controls access permissions, monitors system performance, and handles any administrative tasks related to the platform. In an embodiment, the administrator module 320 interacts with any or all other modules to promote compliance with the administrative settings. Further, a backend administration system allows users with administrative privileges to perform various administrative tasks associated with the module as described herein, such as initiating a data collection and/or correlation process, a neural network training process, defining optimization goals, defining execution parameters/criteria, and any other defined settings discussed herein.

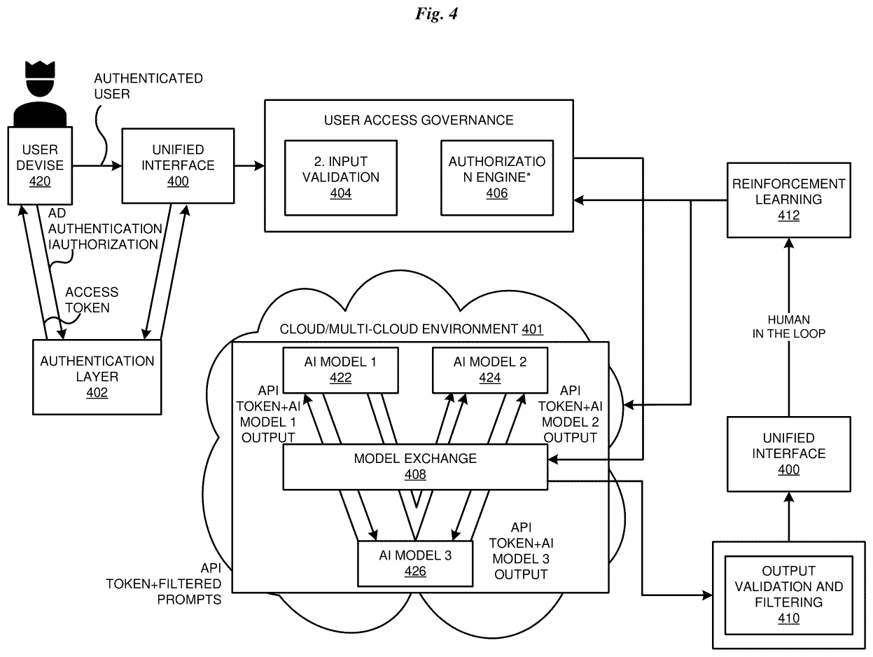

FIG. 4 depicts a block diagram of an example process for validating data exchange and generation. In the illustrated embodiment, unified interface module 400 is an example of unified interface module 200 of FIGS. 1 and 2, and/or unified interface module 300 of FIG. 3.

In the illustrated embodiment, a user accessing user device 420 is shown transmitting a prompt via the unified interface module 400. In the illustrated embodiment, the user device 420 connects to an authentication layer 402 that verifies the identity of user device 420 prior to transmitting a prompt via the unified interface module 400. In the illustrated embodiment, upon authenticating user device 420, the prompt is transmitted to a user access governance module. In an embodiment, the user access governance module includes an input validation module 404 configured to validate the content of the input prompt. In an embodiment, upon validating the content of the input prompt, an authorization engine module 406 authorizes one or more models of a multi-model system environment 401 to perform one or more operations to process the input prompt.

In the illustrated embodiment, the multi-model system environment 401 includes a first model 422, a second model 424, and a third model 426. In an embodiment, each model of the plurality of models may be a different type of model. In an embodiment, each model of the plurality of models may be configured to perform a different type of data processing or data generation operation. In an embodiment, each model of the plurality of models may be trained or configured for a different use-case of an enterprise. In an embodiment, each model of the plurality of models may be configured to access, transmit, and/or modify different types of stored data based on configuration of the model. In an embodiment, the executing the first model 422 to execute first task comprises retrieving information from a first database, executing the second model 424 to execute second task comprises retrieving information from a second database, and executing the third model 426 to execute third task comprises retrieving information from a third database. In an embodiment, each model and/or databases may correspond to a different security posture. Although three models are shown for the sake of clarity, it is contemplated herein that the multi-model system environment 401 may include any number of AI/ML models. In an embodiment,

In the illustrated embodiment, the model exchange module 408 is configured to facilitate interaction and data exchange between the first model 422, the second model 424, and the third model 426. In an embodiment, the model exchange module 408 acts as a central hub that coordinates the exchange of data and interactions between the first model 422, the second model 424, and the third model 426. In an embodiment, the model exchange module 408 executes specifically purposed code for selecting, loading, and routing data between the models based on the task requirements, user permissions, and/or system policies. In an embodiment, the model exchange module 408 includes one or more programmed mechanisms to handle data transformation and/or format conversion between the first model 422, the second model 424, and the third model 426 to facilitate data exchange and interoperability between the models.

In an embodiment, the authorization engine 406 interacts with the model exchange module 408 to facilitate data exchange and interaction between the first model 422, the second model 424, and the third model 426 within the multi-model system 401. The authorization engine 406 determines user permissions, access control, and security policies related to the models, while the model exchange module 408 manages the actual exchange of data and communication between the models. In an embodiment, the authorization engine 406 communicates with the model exchange module 408 to validate user permissions and access rights before data exchange occurs between the models. The authorization engine module 406 provides that users have the necessary authorization to interact with specific models and that data exchange aligns with defined security protocols and policies.

In an embodiment, model exchange module 408 transmits a generated output to the output validation and filtering module 410. In an embodiment, the generated output includes a final processing result produced from a combination of interactions between the first model 422, the second model 424, and the third model 426. In some embodiments, each individual generated output of each model is validated and/or filtered prior to being transmitted for further processing by another model. After the model exchange module 408 processes the input data and generates an output from the interaction between different models, the module forwards this output to the output validation and filtering module 410 for further filtering and validation before final delivery to the user or subsequent processing steps. The output validation and filtering module 410 checks the output for sensitive information, inappropriate content, or deviations from expected output standards, providing that only valid and appropriate information is passed on for further processing or presentation.

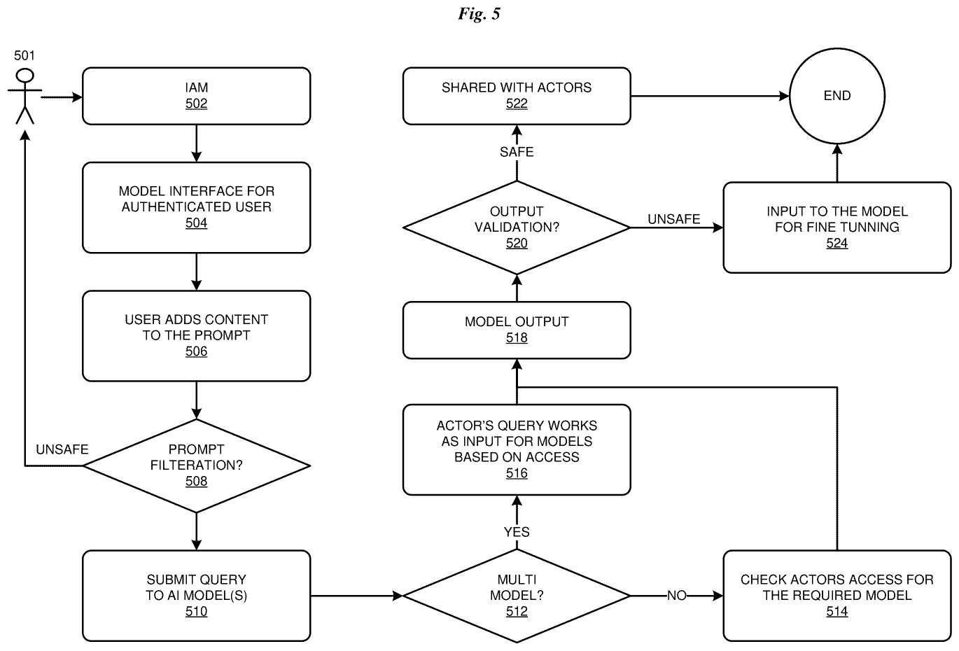

FIG. 5 depicts a block diagram of an example process for validating data exchange and generation. In an embodiment, aspects of the depicted process may be carried out in whole or in part by unified interface module 200 of FIGS. 1 and 2, and/or unified interface module 300 of FIG. 3.

In the illustrated embodiment, a user 501 is shown attempting to interact with a target system. For example, the user 501 may generate a prompt to transmit to a large language model employed by the target system. In an embodiment, at block 502 the user 501 is granted access according to an IAM layer. Once the user 501 is authenticated by the IAM layer, the process proceeds to step 504 where the user 501 gains access to a model interface for facilitating data exchange and interaction between different models belonging to the target system. In an embodiment, at block 506, the user 501 creates content to enter into an input prompt for a model. In an embodiment, at block 508, the process employs a prompt filtering technique to determine whether the prompt contains any prohibited content. If the prompt filtering technique detects prohibited content, then a signal indicating that the prompt is unsafe is transmitted back to the user. Otherwise, if the prompt filtering technique does not detect any prohibited content, the process proceeds to block 510 and a query containing the input prompt is transmitted for further processing to one or more models.

In an embodiment, at block 512, the process determines whether the query includes a task that may be accomplished by one or more models. In an embodiment, upon a determination that multiple models will not be employed by more than one model, the process proceeds to step 514 and checks the actor's access for the one model. In an embodiment, upon a determination that multiple models may be employed to accomplish the one or more tasks defined by the query, the process proceeds to step 516 to determine that the actor's query is appropriate and/or valid for multiple models based on the user's access permissions. In an embodiment, the process assesses whether the actor's query is suitable and valid for multiple models based on the user's access permissions by verifying that the user's access permissions align with the requirements of the multiple models being considered for task execution. By confirming that the user has the necessary permissions to interact with the selected models, the system ensures that the query can be appropriately processed, and that the user is authorized to engage with the candidate models.

In an embodiment, at block 516, the process further validates the appropriateness and validity of the actor's query for multiple models by cross-referencing the query content with the capabilities and functionalities of the selected models. This assessment ensures that the query is compatible with the features and expertise offered by each model, allowing for effective utilization of the models to address the specified tasks. By confirming that the query is relevant and applicable to the selected models, the system optimizes the utilization of resources and enhances the likelihood of achieving successful outcomes for the user. Further, the process considers the user's access permissions in conjunction with the nature of the query and the capabilities of the multiple models to determine the suitability of employing these models for task execution. By aligning the user's permissions with the query requirements and the capabilities of the models, the process validates that the user is authorized to leverage the selected models for processing the query.

In an embodiment, at block 518, the one or more models generates an output. In an embodiment, at step 520, the process validates the output generated by the one or more models. In an embodiment, upon a determination that the output contains prohibited content, the process proceeds to step 524 where the output is tagged as unsafe and transmitted for further use as input to fine tuning the one or more models. In an embodiment, upon a determination that the output does not contain prohibited content, the process proceeds to step 522 and shares the output with relevant actors.

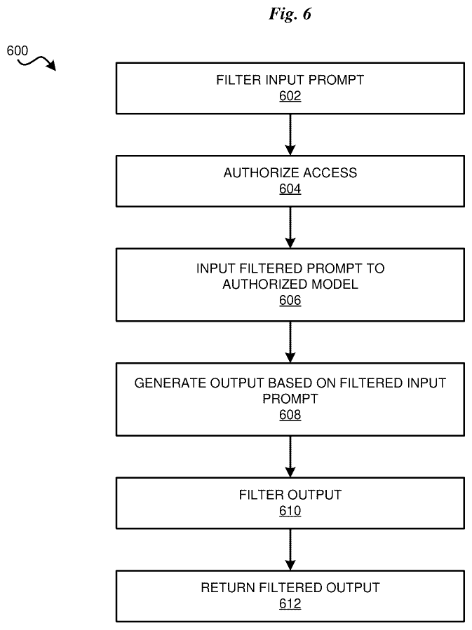

FIG. 6 depicts a flowchart of an example process for prompt debugging in accordance with an illustrative embodiment. In an embodiment, unified interface module 200 of FIGS. 1 and 2, unified interface module 300 of FIG. 3 carries out some or all of the steps of process 600.

In an embodiment, at step 602, the process includes filtering an input prompt. In an embodiment, the filtering process includes analyzing the input prompt to identify and remove any objectionable content, sensitive data, or irrelevant information that could impact the accuracy or integrity of the subsequent processing steps. In an embodiment, the process causes an execution of a specifically programmed code to filter the input prompt. In an embodiment, an input filter module of unified interface application is configured to execute the specifically programmed code to filter the input prompt. By applying content filtering techniques, the process can screen out noise, errors, or unwanted elements from the input prompt. Further, content filtering of the input prompt may also include checking for compliance with predefined criteria, such as regulatory requirements, data privacy standards, or specific task constraints.

In an embodiment, the process includes detecting and filtering query content that contains text data indicative of malicious intent, such as attempts to exploit vulnerabilities, inject malicious code, or manipulate the model's behavior. In an embodiment, the process includes monitoring and screening incoming queries for suspicious patterns, unauthorized commands, or known attack signatures. Further, by screening queries for personally identifiable information (PII), confidential data, or proprietary content, the process can prevent unauthorized disclosure of sensitive data and protect the privacy and security of user information. The same or similar types of content filtering techniques can be applied to the output of a model to ensure the integrity, relevance, and compliance of the generated information as well as to mitigate the risk of data leakage or unauthorized access to sensitive information through query-based attacks on an LLM model.

In an embodiment, at step 604, the process includes authorizing access to a large language model. In an embodiment, the process includes verifying the user's identity, authentication credentials, and permissions to ensure that only authorized users can interact with the large language model. In an embodiment, the process causes an execution of specifically programmed code to authorize one or more large language models for execution based on task requirements and/or user permissions. In an embodiment, model authorization engine of a unified interface application is configured to execute the specifically programmed code to authorize a model for execution. By authorizing access, the system maintains security and control over who can utilize the model and its capabilities, preventing unauthorized usage and safeguarding sensitive information.

In an embodiment, at step 604, the process of authorizing access to a large language model may involve authorizing multiple models in a multi-model system environment based on the prompt content, task requirements, and user permissions. The authorization process considers the content of the input prompt provided by the user, analyzing the context, keywords, and requirements specified in the prompt. Based on this analysis, the system determines which models are best suited to address the user's query effectively. Different models may excel in specific domains, tasks, or languages, and the authorization process selects the most relevant models based on the prompt content.

Furthermore, the authorization of multiple models takes into consideration the task requirements associated with the input prompt. Some tasks may require specialized models with domain-specific knowledge or capabilities, while others may be more general in nature. By evaluating the task requirements outlined in the prompt, the process authorizes models that are most suitable for fulfilling the task requirements. Further, user permissions may dictate which models a user can access, interact with, and receive outputs from, based on their roles, responsibilities, and privileges within the system. By aligning user permissions with model authorization, the process maintains security, control, and compliance in managing model access.

In an embodiment, at step 606, the process includes inputting a filtered prompt to the authorized model. After access authorization is granted, the user provides a prompt that has undergone a filtering process to ensure the prompt content meets predefined criteria such as objectionable content, regulatory compliance, or data sensitivity. The filtered prompt is then submitted to the authorized large language model for processing, ensuring that only appropriate and compliant inputs are used for generating outputs. In an embodiment, the filtered prompt includes a modified version of the input prompt intercepted from a user device.

In an embodiment, at step 608, the process includes generating an output based on the input filtered prompt. The authorized large language model processes the filtered prompt to generate an output that is relevant to the user's query or request. In an embodiment, at step 610, the process includes filtering the output generated by the large language model. Once the output is generated, the process employs a filtering process to validate its accuracy, relevance, and compliance with predefined criteria. In an embodiment, the process checks the output for sensitive information, inappropriate content, or any deviations from the expected output criteria. Filtering the output ensures that only valid and appropriate information is presented to the user or transmitted to another model for further processing.

In an embodiment, at step 612, the process includes returning the output generated by the large language model. After the output has been filtered and validated, the modified output may be returned to the user who initiated the query or request. The user receives the processed output, which may include answers to questions, recommendations, or other relevant information based on the input prompt. In an embodiment, at step 612, the process of returning the output generated by the large language model may include using the output as an input to another machine learning model. After the large language model generates an output based on the input prompt, the output is captured and formatted to serve as input data for another machine learning model in the system. The subsequent model may specialize in different aspects of data analysis, pattern recognition, or decision-making, in a cascading configuration that leverages the configuration of the initial model or any other previous model.

The chaining of models allows for a more comprehensive analysis of the input data, leveraging the strengths of each model in a coordinated fashion to achieve enhanced output results. Embodiments of the present disclosure provide mechanisms for interfacing between different models in a cascading configuration, such that each model in a chain is authorized to transmit and process data based on user permissions, data relevance, and/or data sensitivity. In an embodiment, output from one model is filtered and validated before being transmitted to another model in accordance with the prompt content, task requirements, user permissions, and defined policies. This process ensures that the output is carefully assessed for sensitive information, inappropriate content, or deviations from expected criteria. The filtering step aligns the output with the prompt content and task specifications, while the validation process confirms its accuracy and relevance. By following these steps, the process provides that only validated and compliant information is passed on to the subsequent model for processing,

Suppose for example that a successful execution of some task based on a user input query requires execution of multiple sub-tasks, such as a first task and a second task. In an embodiment, the process may include executing a first model to execute the first task and executing a second model to execute the second task. In an embodiment, executing the first model to execute the first task comprises retrieving information from a first database. In an embodiment, the first database comprises a first security posture. In an embodiment, executing the second model to execute the second task comprises retrieving information a second database. In an embodiment, the second database comprising a second security posture. By requiring validation of access to both models and/or databases based on the security postures of the respective databases, systems and organizations can maintain a granular level of control over user access rights, mitigate the risk of unauthorized data access or manipulation, and uphold the confidentiality and integrity of the data stored within each database.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
intercepting, using a unified interface software application, an input transmitted from a user device a target system, the input comprising text data;
causing, responsive to the intercepting, an execution of a first specific program instruction, the execution of the first specific program instruction validating an identity of the user device transmitting the input;
causing, responsive to validating the identity of the user device, an execution of a second specific program instruction, the execution of the second specific program instruction filtering the text data, the filtering comprising identifying restricted content within the text data, and removing a portion of text data from the input corresponding to the identified restricted content, the filtering producing a modified input;
authorizing using a model authorization engine of the unified interface software application a first model to execute a first task identified in the modified input;
executing, responsive to the authorizing, the first model to execute the first task, the executing producing a first execution result, the first execution result comprising text data;
causing, responsive to the executing, an execution of a third specific program instruction filtering the text data of the first execution result, the filtering comprising identifying restricted content within the text data, and removing a portion of text data from the first execution result corresponding to the identified restricted content, the filtering producing a modified text output; and
returning, responsive to the filtering, the modified text output to the user device.

2. The computer-implemented method of claim 1, the method further comprising:
authorizing using the model authorization engine of the unified interface software application a second model to execute a second task identified in the modified input;
executing, responsive to the authorizing, the second model to execute the second task, the executing producing a second execution result, the second execution result comprising text data; and
causing, responsive to the executing, an execution of a fourth specific program instruction filtering the text data of the second execution result, the filtering comprising identifying restricted content within the text data, and removing a portion of text data from the second execution result corresponding to the identified restricted content, the filtering producing a second modified text output.

3. The computer-implemented method of claim 2,
wherein the executing the first model to execute the first task comprises retrieving information from a first database, the first database comprising a first security posture; and
wherein the executing the second model to execute the second task comprises retrieving information from a second database, the second database comprising a second security posture.

4. The computer-implemented method of claim 1, the method further comprising:
authorizing using the model authorization engine of the unified interface software application a third model to execute a third task identified in the modified text output;
executing, responsive to the authorizing, the third model to execute the third task, the executing producing a third execution result, the third execution result comprising text data;
causing, responsive to the executing, an execution of a fifth specific program instruction filtering the text data of the third execution result, the filtering comprising identifying restricted content within the text data, and removing a portion of text data from the third execution result corresponding to the identified restricted content, the filtering producing a third modified text output; and
returning, responsive to the filtering, the third modified text output to the user device.

5. The computer-implemented method of claim 1, wherein the validating further comprises:
establishing a user profile database, the user profile database storing a set of user profiles;
comparing the identity associated with the user device to the set of user profiles; and
validating, responsive to matching the identity associated with the user device to a user profile of the set of user profiles, the identity of the user device.

6. The computer-implemented method of claim 5, wherein authorizing the first model to execute a first task is based on a combination of a set of task requirements of the first task and a set of user access permissions corresponding to the user profile.

7. The computer-implemented method of claim 5, the method further comprising:
validating according to a set of user access permissions corresponding to the user profile that the user device is authorized to receive information contained within the modified text output; and
returning, responsive to the validating, the modified text output to the user device.

8. A computer program product comprising one or more computer readable storage media, and program instructions collectively stored on the one or more computer readable storage media, the program instructions executable by a processor to cause the processor to perform operations comprising:
intercepting, using a unified interface software application, an input transmitted from a user device a target system, the input comprising text data;
causing, responsive to the intercepting, an execution of a first specific program instruction, the execution of the first specific program instruction validating an identity of the user device transmitting the input;
causing, responsive to validating the identity of the user device, an execution of a second specific program instruction, the execution of the second specific program instruction filtering the text data, the filtering comprising identifying restricted content within the text data, and removing a portion of text data from the input corresponding to the identified restricted content, the filtering producing a modified input;
authorizing using a model authorization engine of the unified interface software application a first model to execute a first task identified in the modified input;
executing, responsive to the authorizing, the first model to execute the first task, the executing producing a first execution result, the first execution result comprising text data;
causing, responsive to the executing, an execution of a third specific program instruction filtering the text data of the first execution result, the filtering comprising identifying restricted content within the text data, and removing a portion of text data from the first execution result corresponding to the identified restricted content, the filtering producing a modified text output; and
returning, responsive to the filtering, the modified text output to the user device.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, further comprising:
authorizing using the model authorization engine of the unified interface software application a second model to execute a second task identified in the modified input;
executing, responsive to the authorizing, the second model to execute the second task, the executing producing a second execution result, the second execution result comprising text data; and
causing, responsive to the executing, an execution of a fourth specific program instruction filtering the text data of the second execution result, the filtering comprising identifying restricted content within the text data, and removing a portion of text data from the second execution result corresponding to the identified restricted content, the filtering producing a second modified text output.

12. The computer program product of claim 11,
wherein the executing the first model to execute the first task comprises retrieving information from a first database, the first database comprising a first security posture; and
wherein the executing the second model to execute the second task comprises retrieving information a second database, the second database comprising a second security posture.

13. The computer program product of claim 8, further comprising:
authorizing using the model authorization engine of the unified interface software application a third model to execute a third task identified in the modified text output;
executing, responsive to the authorizing, the third model to execute the third task, the executing producing a third execution result, the third execution result comprising text data;
causing, responsive to the executing, an execution of a fifth specific program instruction filtering the text data of the third execution result, the filtering comprising identifying restricted content within the text data, and removing a portion of text data from the third execution result corresponding to the identified restricted content, the filtering producing a third modified text output; and
returning, responsive to the filtering, the third modified text output to the user device.

14. The computer program product of claim 8, wherein the validating further comprises:
establishing a user profile database, the user profile database storing a set of user profiles;
comparing an identity associated with the user device to the set of user profiles; and
validating, responsive to matching the identity associated with the user device to a user profile of the set of user profiles, the identity of the user device.

15. The computer program product of claim 14, wherein authorizing the first model to execute a first task is based on a combination of a set of task requirements of the first task and a set of user access permissions corresponding to the user profile.

16. The computer program product of claim 14, further comprising:
validating according to a set of user access permissions corresponding to the user profile that the user device is authorized to receive information contained within the modified text output; and
returning, responsive to the validating, the modified text output to the user device.

17. A computer system comprising a processor and one or more computer readable storage media, and program instructions collectively stored on the one or more computer readable storage media, the program instructions executable by the processor to cause the processor to perform operations comprising:
intercepting, using a unified interface software application, an input transmitted from a user device a target system, the input comprising text data;
causing, responsive to the intercepting, an execution of a first specific program instruction, the execution of the first specific program instruction validating an identity of the user device transmitting the input;
causing, responsive to validating the identity of the user device, an execution of a second specific program instruction, the execution of the second specific program instruction filtering the text data, the filtering comprising identifying restricted content within the text data, and removing a portion of text data from the input corresponding to the identified restricted content, the filtering producing a modified input;
authorizing using a model authorization engine of the unified interface software application a first model to execute a first task identified in the modified input;
executing, responsive to the authorizing, the first model to execute the first task, the executing producing a first execution result, the first execution result comprising text data;
causing, responsive to the executing, an execution of a third specific program instruction filtering the text data of the first execution result, the filtering comprising identifying restricted content within the text data, and removing a portion of text data from the first execution result corresponding to the identified restricted content, the filtering producing a modified text output; and
returning, responsive to the filtering, the modified text output to the user device.

18. The computer system of claim 17, further comprising:
authorizing using the model authorization engine of the unified interface software application a second model to execute a second task identified in the modified input;
executing, responsive to the authorizing, the second model to execute the second task, the executing producing a second execution result, the second execution result comprising text data; and
causing, responsive to the executing, an execution of a fourth specific program instruction filtering the text data of the second execution result, the filtering comprising identifying restricted content within the text data, and removing a portion of text data from the second execution result corresponding to the identified restricted content, the filtering producing a second modified text output.

19. The computer system of claim 18, wherein the executing the first model to execute the first task comprises retrieving information from a first database, the first database comprising a first security posture; and
wherein the executing the second model to execute the second task comprises retrieving information from a second database, the second database comprising a second security posture.

20. The computer system of claim 17, further comprising:
authorizing using the model authorization engine of the unified interface software application a third model to execute a third task identified in the modified text output;
executing, responsive to the authorizing, the third model to execute the third task, the executing producing a third execution result, the third execution result comprising text data;
causing, responsive to the executing, an execution of a fifth specific program instruction filtering the text data of the third execution result, the filtering comprising identifying restricted content within the text data, and removing a portion of text data from the third execution result corresponding to the identified restricted content, the filtering producing a third modified text output; and
returning, responsive to the filtering, the third modified text output to the user device.
